(19) United States
(12) Patent Application Publication
(10) Pub. No.: US 2009/0018960 A1
(43) Pub. Date: Jan. 15, 2009

(54) Method of operating a remote check image capture system and an apparatus therefor

(75) Inventor: Stephen C. Gawne, Waterloo (CA)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 11/827,867

(22) Filed: Jul. 13, 2007

(51) Int. Cl. G06Q 40/00

(52) U.S. Cl. 705/45

(57) ABSTRACT

A method is provided of operating a remote check image capture system. The method comprises scanning a batch of checks to provide a stream of captured check images, locally storing the captured check images, and transmitting the captured check images to a bank server while other checks are being scanned to enable a human operator to begin balancing checks without having to wait until all checks of the batch of checks have been scanned.

### BACKGROUND

The present invention relates to check image capture, and is particularly directed to a method of operating a remote check image capture system and an apparatus therefor.

A typical remote check image capture system includes a remote capture client and a check scanner located at the remote capture client. The remote capture client communicates over a communications network with a bank server. When a human operator is processing checks at the remote capture client, each check is scanned using the check scanner to provide check image data which is representative of the check. The check image data is stored in a check image data memory. The operator batches the checks and balances the batched checks before transmitting the work including check images to the bank server for further processing. The operator then waits to receive an acknowledgement from the bank server that the work has been accepted at the bank.

The amount of check image data transmitted to the bank server is usually quite large. For example, the amount of check data including image data transmitted may be as large as fifty megabytes of data. If the amount of check data including image data being transmitted to the bank server is a large amount, then the amount of time required to complete the transmission is also a large amount. It would be desirable to improve the overall workflow described hereinabove in which check data including image data is initially captured at the remote capture client, and then subsequently transmitted to the bank server.

### SUMMARY

In accordance with one embodiment of the present invention, a method is provided of operating a remote check image capture system. The method comprises scanning a batch of checks to provide a stream of captured check images, locally storing the captured check images, and transmitting the captured check images to a bank server while other checks are being scanned to enable a human operator to begin balancing checks without having to wait until all checks of the batch of checks have been scanned.

### BRIEF DESCRIPTION OF THE DRAWINGS

In the accompanying drawings:

FIG. 1 is a block diagram of a remote check image capture system constructed in accordance with one embodiment of the present invention;

FIG. 2 is a flowchart illustrating steps invoked by a remote capture client check processing program in the remote check image capture system of FIG. 1; and

FIG. 3 is a flowchart illustrating steps invoked by a bank server check processing program in the remote check image capture system of FIG. 1.

### DETAILED DESCRIPTION

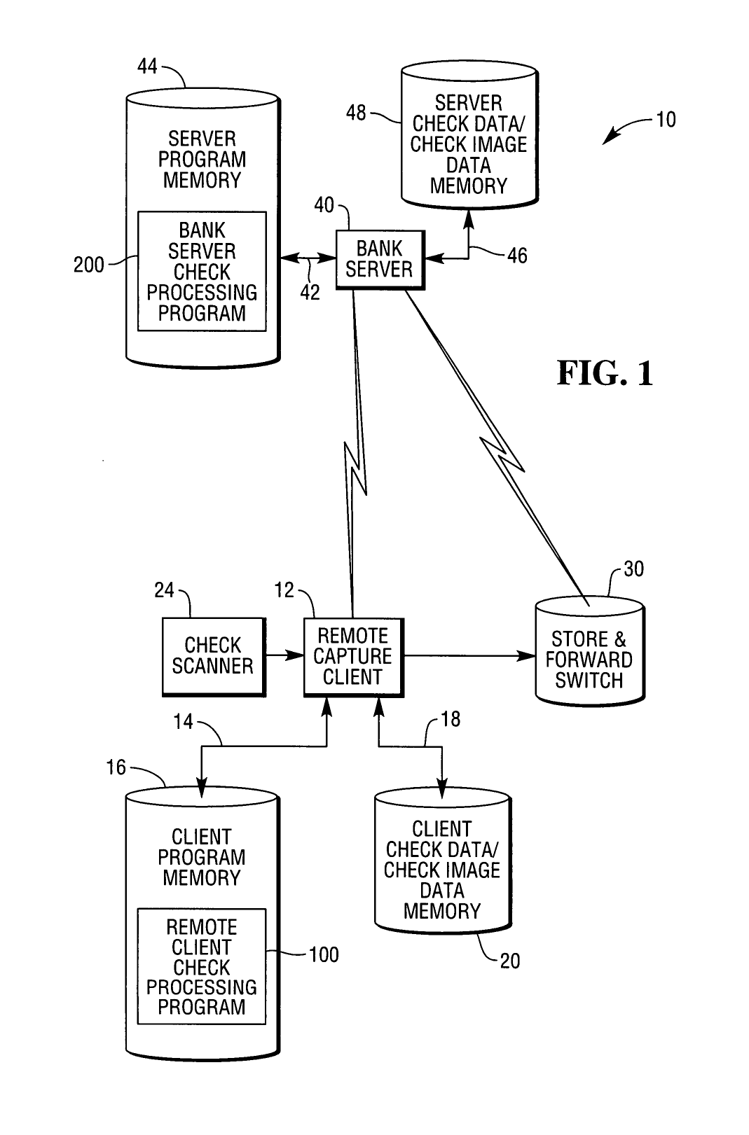

The present invention is directed to a method of operating a remote check image capture system and an apparatus therefor. Referring to FIG. 1, a remote check image capture system 10 includes a remote capture client 12 which communicates via line 14 with a client program memory 16 and via line 18 with a client check data/check image data memory 20. The program memory 16 stores a number of application programs including a remote client check processing program 100 to be described in detail later. The client check data/check image data memory 20 stores check data including check image data which is representative of captured images of checks. The remote capture client 12 may comprise a conventional desktop computer with a graphical user interface. Suitable computers and graphical user interfaces are readily available in the marketplace. Their structure and operation are well known and, therefore, will not be described.

The remote check image capture system 10 further includes a check scanner device 24 for scanning checks and capturing images of the scanned checks. The check scanner device 24 may comprise any type of image scanner in which either the check is moved past the scanner or the scanner is moved past the check. For example, the check scanner device 24 may comprise a table-top check processing terminal located at a bank branch, for example, where bank personnel use the terminal to perform check processing functions. As another example, the check scanner device 24 may be located at a commercial facility where check processing functions are performed.

During operation, the check scanner device 24 lifts an image of a check when the check is moved past the check scanner device. Lifted check images are stored in the client check data/check image data memory 20. The process of lifting an image of a check using the check scanner device 24, and then storing the lifted check image in the client check data/check image data memory 20 is known and, therefore, will not be described. As check images are being lifted and stored in the client check data/check image data memory 20, the lifted check images are transmitted to a store and forward switch 30. The store and forward switch 30 transmits check images to a bank server 40 in accordance with program steps of the remote client check processing program 100.

After all checks have been scanned in the system 10 of FIG. 1, a human operator batches and balances the batched checks, and provides resulting balancing edit data. The operator then invokes the remote client check processing program 100 via the remote capture client 12 to transmit the balancing edit data to a bank server 40 for further processing at the bank server facility. The operator then waits to receive an acknowledgement signal from the bank server 40 to indicate that the bank server facility has accepted the work (i.e., the check images and the balancing edit data) at the bank.

The bank server 40 communicates via line 42 with a server program memory 44 and via line 46 with a server check data/check image data memory 48. The server program memory 44 stores a number of application programs including a bank server check processing program 200 to be described in detail later. The server check data/check image data memory 48 stores check image data and balancing edit data received from the remote capture client 12.

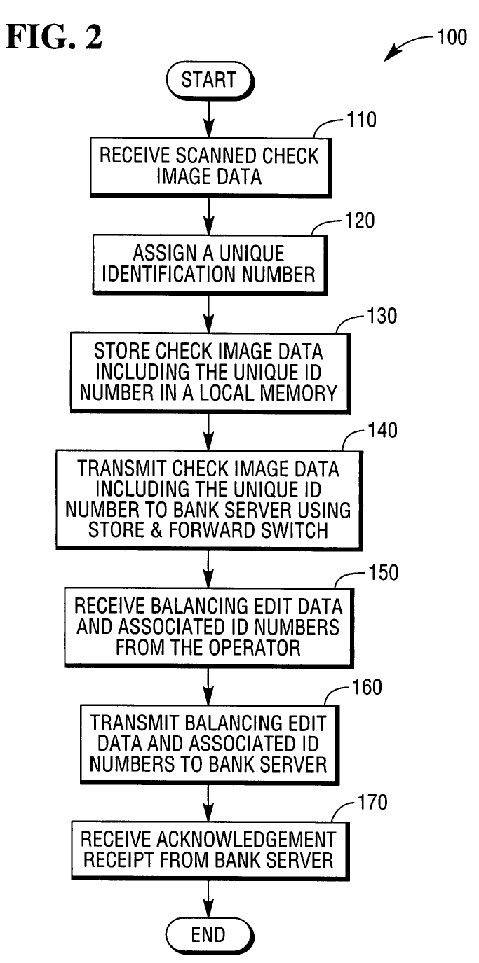

Referring to FIG. 2, a flowchart 100 depicts steps performed by the remote client check processing program 100. In step 110, the remote capture client 12 receives check image data which has been lifted from scanned checks. After the check image data is received, a unique identification number is assigned and associated with each check image (step 120). The check image data and the unique identification number which has just been assigned are stored in the client check data/check image data memory 20 (step 130). The check image data and the unique identification number are also transmitted to the bank server 40 via the store and forward switch 30 (step 140).

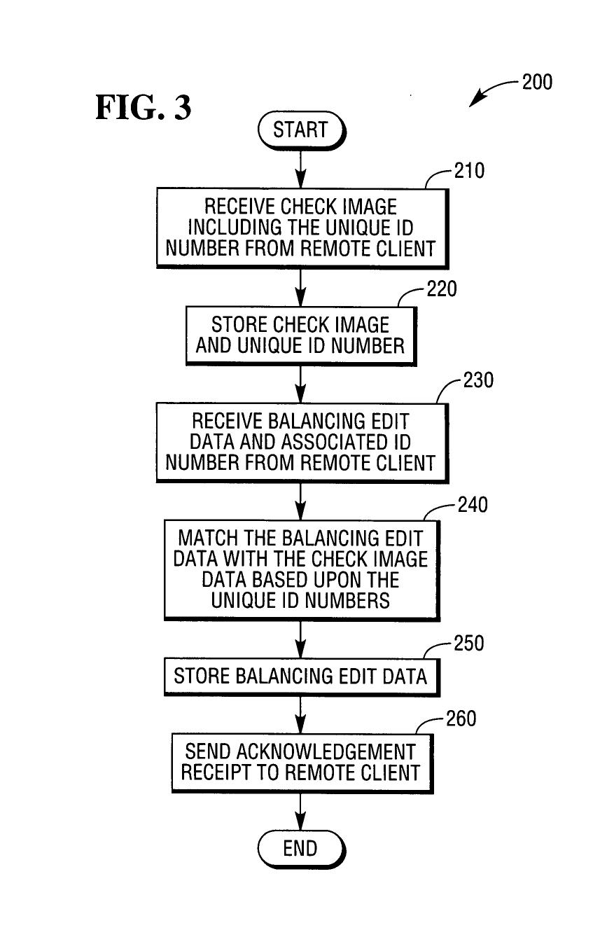

As an operator performs check balancing functions on the check images and provides balancing edit data, the association of each unique identification number with its corresponding check image is maintained. The remote capture client 12 receives this balancing edit data and identification numbers associated with the balancing edit data (step 150). The remote capture client 12 then transmits the balancing edit data along with the associated identification numbers to the bank server 40 for further processing at the bank server facility (step 160). After the bank server 40 processes the balancing edit data (as will be described below in the flowchart of FIG. 3), the bank server provides an acknowledgement signal which is transmitted to the remote capture client 12. The remote capture client 12 receives this acknowledgement signal as shown in step 170.

Referring to FIG. 3, a flowchart 200 depicts steps performed by the bank server check processing program 200. In step 210, the bank server 40 receives each check image including the associated unique identification number which has been assigned to the check image and transmitted from the remote capture client 12, as was described in steps 120 and 140 shown in FIG. 2. Each check image including the associated unique identification number are stored in the server check data/check image data memory 48 (step 220). At a later time in step 230, the bank server 40 receives balancing edit data and associated identification numbers from the remote capture client 12, as was described in step 160 shown in FIG. 2.

After the balancing edit data along with associated identification numbers are received from the remote capture client 12, the balancing edit data is matched up with check images stored in the server check data/check image data memory 48 (step 240). This matching up process is based upon matching the identification numbers which accompanied the balancing edit data with the unique identification numbers assigned to the check images. The balancing edit data is then stored along associated check images in the server check data/check image data memory 48 (step 250). Then in step 260, the bank server 40 sends an acknowledgement signal to the remote capture client 12 to indicate that the bank server has received and stored the check images and the balancing edit data, as was described in step 170 in FIG. 2.

It should be apparent that the remote check image capture system 10 provides an improved workflow in which a stream of check images is transmitted from the remote capture client 12 to the bank server 40 immediately after each check image is captured. More specifically, the process of transmitting check images and the process of scanning checks to capture the check images overlap each other. Accordingly, there is no need for the operator to wait until all check images have been captured and balanced at the remote capture client 12 before transmitting the check images to the bank server 40. Since the operator does not need to wait until later to transmit check images from the remote capture client 12 to the bank server 40, the amount of time perceived by the operator to transmit the check images is less.

It should also be apparent that the unique identification number assigned to each check image allows the particular check image to be matched up with its associated balancing edit data which is provided at a later time with the same unique identification number. The unique identification number may be in any form so long as the identification number assigned to a check image is unique to that particular check image.

The particular arrangements disclosed are meant to be illustrative only and not limiting as to the scope of the invention. From the above description, those skilled in the art to which the present invention relates will perceive improvements, changes and modifications. Numerous substitutions and modifications can be undertaken without departing from the true spirit and scope of the invention. Such improvements, changes and modifications within the skill of the art to which the present invention relates are intended to be covered by the appended claims.

What is claimed is:

1. A method of operating a remote check image capture system, the method comprising:
scanning a batch of checks to provide a stream of captured check images;
locally storing the captured check images; and
transmitting captured check images to a bank server while other checks are being scanned to enable a human operator to begin balancing checks without having to wait until all checks of the batch of checks have been scanned.

2. A method according to claim 1, further comprising:
assigning a unique identification number to each captured check image as the associated check is being scanned; and
transmitting the assigned unique identification number along with the associated captured check image to the bank server while other checks are being scanned.

3. A method according to claim 2, further comprising:
receiving balancing edits from the human operator in response to the human operator balancing checks; and
transmitting the balancing edits to the bank server to allow the bank server to match the balancing edits to the earlier transmitted stream of captured check images based upon assigned unique identification numbers.

4. A method comprising:
scanning a batch of checks to provide a stream of captured check images;
transmitting captured check images to a bank server while other checks are being scanned; and
receiving balancing edits from a human operator in response to the human operator balancing checks while captured check images are being transmitted to the bank server.

5. A method according to claim 4, further comprising:
assigning a unique identification number to each captured check image as the associated check is being scanned; and
transmitting the assigned unique identification number along with the associated captured check image to the bank server while balancing edits are being received from the human operator.

6. A method according to claim 5, further comprising:
transmitting the balancing edits to the bank server to allow the bank server to match the balancing edits to the earlier transmitted stream of captured check images based upon assigned unique identification numbers.

7. An apparatus for a remote check image capture system, the apparatus comprising:
a check scanner for scanning a batch of checks to provide a stream of captured check images;
a local memory for storing the stream of captured check images;
a store and forward switch for transmitting the stream of captured check images to a bank server while other checks are being scanned to enable a human operator to begin balancing checks without having to wait until all checks of the batch of checks have been scanned; and
means for (i) assigning a unique identification number to each captured check image as the associated check is being scanned, and (ii) transmitting the assigned unique identification number along with the associated captured check image to the bank server while other checks are being scanned.

8. An apparatus according to claim 7, further comprising:
means for receiving balancing edits from the human operator in response to the human operator balancing checks; and
means for transmitting the balancing edits to the bank server to allow the bank server to match the balancing edits to the earlier transmitted stream of captured check images based upon assigned unique identification numbers.

9. An apparatus according to claim 8, wherein (i) the bank server is located at a back office facility, and (ii) the check scanner comprises a table-top check processing terminal located at a commercial check image capture facility which is located remote from the back office facility.

10. An apparatus according to claim 9, wherein (i) the back office facility comprises a back office facility of a bank, and (ii) the check scanner comprises a table-top check processing terminal located at a bank branch which is located remote from the back office facility of the bank.
